(19) United States
(12) Patent Application Publication
(10) Pub. No.: US 2002/0154780 A1
(43) Pub. Date: Oct. 24, 2002

(54) Method and arrangement for data communication in a cryptographic system containing a plurality of entities

(76) Inventors: Steffen Fries, Muenchen (DE); Wolfgang Klasen, Ottobrunn (DE); Gerald Volkmann, Muenchen (DE)

Correspondence Address: HARNESS, DICKEY & PIERCE, P.L.C., P.O.BOX 8910, RESTON, VA, 20195, US

(21) Appl. No.: 10/108,555

(22) Filed: Mar. 29, 2002

(30) Foreign Application Priority Data
Mar. 29, 2001 (DE) 10115599.9

(51) Int. Cl. H04L 9/00

(52) U.S. Cl. 380/277

(57) ABSTRACT

A method for data communication in a cryptographic system containing a plurality of entities, includes the entities arranged in a hierarchical structure. If a current entity in the hierarchical structure is altered, those entities which are on the same hierarchical level as the current entity, and which are connected to the current entity's superordinate entity, are notified of the alteration.

The present application hereby claims priority under 35 U.S.C. Section 119 on German patent application number DE 10115599.9, the entire contents of which are hereby incorporated herein by reference.

### FIELD OF THE INVENTION

The invention generally relates to a method and an arrangement for data communication in a cryptographic system containing a plurality of entities.

### BACKGROUND OF THE INVENTION

Methods for key distribution and key agreement are known generally (see for example, [1]). In such systems, keys need to be distributed, exchanged or agreed to over an (insecure) communications path. To allow this, the following requirements are of particular significance:

1. Confidentiality:

It is necessary to ensure that the exchanged key is accessible only to the authorized subscribers and processes. Secret keys need to be kept secret during their generation, distribution, storage and—where possible—even during implementation.

2. Identification of data intactness:

It is necessary to take measures to ensure that the exchanged keys are available to the authorized subscribers in an unaltered and error-free state. If a transmission channel is subject to a high level of interference, error-correcting methods may be necessary.

3. Identification of repetition and delays:

One risk is that keys which have already been used will be used a second time, because even then, it may not be possible to distinguish the next communication from an earlier one. This risk exists particularly if a key exchange protocol has been subjected to tapping. Accordingly, delays during key distribution can be regarded as suspicious.

4. Authentication of the origin of the key or subkey:

Key agreement without authentication may be pointless, because this might be done with a potential hacker. This is prevented by virtue of additional authentication subsequently being carried out using keys which have already been exchanged or securely agreed beforehand.

5. Acknowledgement of receipt and verification of the agreed key:

The acknowledgement of receipt is intended to prove to the sender that the rightful recipient has received the key correctly. Since the exchanged keys are frequently not used directly, but rather serve as subkeys, references, etc., dynamically agreed keys need to be tested before they are used. This verification can be carried out explicitly by reciprocal transformation of prescribed data or implicitly by redundancy added to the protocol elements of the exchange protocol.

The result of this list of requirements, which is not conclusive (or inclusive), is that, when they are observed, key distribution which can be implemented with a high level of security is possible.

A particular peculiarity of today's electronic systems is that they are implemented in distributed form. Consequently, a plurality of computers (also: entities, processes, processors, nodes, subscribers) are amalgamated in a network, with the computers being able to communicate with one another. Within the context of key distribution, it is also known practice for the subscribers in the network to be provided with a hierarchical structure. In this context, a particularly popular structure is a tree structure comprising a root node and branches and nodes, with the nodes, which themselves have no nodes on a lower level, being referred to as leaves of the tree structure.

If a method for key distribution is applied to a hierarchical structure of nodes, in particular to a tree structure, then the alteration of a node needs to involve negotiation of at least one new key for the entire system, that is to say the entire tree. The new key needs to be communicated to all the nodes of the tree. In this context, a particular drawback is that every node receives a new key and that the same key is always used between two respective nodes. Even if just one particular key (or a symmetrical key pair) is used between two respective nodes, it is a drawback that received data need to be recoded separately for each key and recipient.

### SUMMARY OF THE INVENTION

One object of an embodiment of the invention is to present an efficient and economical method for key distribution which avoids at least one of the drawbacks described above.

An object of an embodiment of the invention can be achieved by specifying a method for data communication in a cryptographic system containing a plurality of entities, in which the entities can be arranged in a hierarchical structure. If a current entity in the hierarchical structure is altered, those entities which are on the same hierarchical level as the current entity and which are connected to the current entity's superordinate entity, can be notified of the alteration.

This can advantageously ensure that an association of entities is formed which comprises part of the hierarchical structure and allows separate key distribution for this part.

One development of an embodiment can be that the data communication comprises a method for key distribution.

Another development of an embodiment can be that the plurality of entities are nodes or subscribers to the data communication.

A further development of an embodiment can be that the plurality of entities are amalgamated in a network.

Another development of an embodiment can be that the hierarchical structure is a tree structure.

One particular development of an embodiment can be that the alteration of the current entity comprises at least one of the following options:

a) the current entity is added;

b) the current entity is removed;

c) at least one property of the current entity is altered.

Another development of an embodiment can be that the notification of alteration involves a modified cryptographic key being transmitted. A further development of an embodiment can be that the method for implementing multicast services can be used. This can include a sender simultaneously transmitting to a plurality of recipients, data encrypted in the same manner, with each recipient being able to perform decryption using the key information associated with the sender.

In addition, an object of an embodiment can be achieved by specifying an arrangement for data communication in a cryptographic system containing a plurality of entities, in which a processor unit is provided which is set up such that

a) the entities are arranged in a hierarchical structure;

b) if the current entity is altered, those entities which are on the same hierarchical level as the current entity and which are connected to the current entity's hierarchically superordinate entity, are notified of the alteration.

An embodiment of the inventive arrangement can be particularly suitable for carrying out the inventive method or one of its developments explained above.

### BRIEF DESCRIPTION OF THE DRAWINGS

Exemplary embodiments of the invention are illustrated and explained with reference to the figures below, in which

FIG. 1 shows a sketch with a hierarchical structure comprising a plurality of nodes;

FIG. 2 shows a sketch with a hierarchical tree structure and group keys;

FIG. 3 shows a sketch illustrating the addition of a further node;

FIG. 4 shows a sketch of a hierarchical structure with steps in a method for data distribution;

FIG. 5 shows a processor unit.

### DETAILED DESCRIPTION OF THE PREFERRED EMBODIMENTS

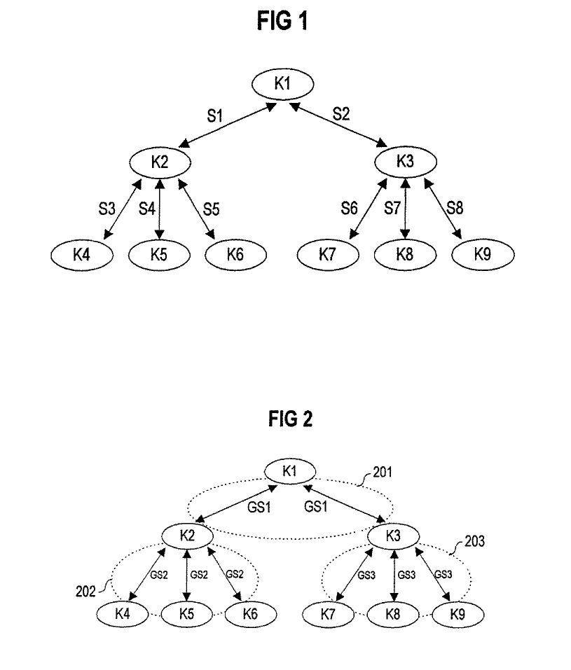

FIG. 1 shows a sketch with a hierarchical structure comprising a plurality of nodes. In this case, by way of example, a root node K1 is shown which is connected to a node K2 via an edge and to a node K3 via an edge. The node K2 is in turn connected to hierarchically subordinate nodes K4, K5 and K6 (in each case via an edge). Similarly, the node K3 is connected to nodes K7, K8 and K9 via a respective edge. Between the node K1 and the node K2, there is a symmetrical key S1 for data encryption. Similarly, there is a key S2 between the nodes K1 and K3, a key S6 between the nodes K3 and K7, a key S7 between the nodes K3 and K8, and a key S8 between the nodes K3 and K9. In addition, there is a key S3 between the nodes K2 and K4, a key S4 between the nodes K2 and KS, and a key S5 between the nodes K2 and K6.

The symmetrical keys S1 to S8 can, in particular, also be in the form of a symmetrical key pair for data encryption between two respective nodes. The key pair ensures that an asymmetric encryption method can be carried out between two respective nodes.

In the embodiment shown in FIG. 1, a particular drawback is that a message which needs to be transmitted to another node, as a current node's directly adjacent node, needs to be repeatedly recoded. In this respect, a “multicast data transfer”, that is to say notification of a plurality of nodes without separate respective encryption, is not possible.

FIG. 2 shows a sketch with a hierarchical tree structure and group keys, where this structure supports a multicast data transfer, in particular.

The nodes K1 to K9 are arranged in accordance with FIG. 1. In this context, each node is a possible initiator for key distribution. The key distribution can be initiated when particular data within the tree structure, be it for the nodes or the structure, change or when the keys need to be renewed at a predetermined time. In particular, addition or removal of a node can involve a change being made to the tree structure such that a new key distribution results.

A group can be determined by all the nodes on a hierarchical level and their common superordinate nodes. In relation to FIG. 2, this produces:

Group 201, comprising the nodes K1, K2, K3;

Group 202, comprising the nodes K4, K5, K6, K2;

Group 203, comprising the nodes K7, K8, K9, K3.

Within each group, a method for key distribution can be negotiated; if the composition of a group changes, then its group key also changes. Expediently, the information about the composition of the group can be entered into the respective group key.

An advantage in this context is that a change to a group does not require a new key to be created and distributed for all the nodes (entities) involved, but rather each group independently represents a separate unit to which the key distribution relates.

For the method for key distribution, each initiator node negotiates a (common) group key with the nodes in the group, the group key being used to protect the data, in particular the integrity and confidentiality thereof.

Another advantage is that a hacking attempt which involves feigning a false identity for a node (masquerade) is not possible, since each group has its own key for encryption. Hence, in FIG. 2:

the group 201 has the group key GS1;

the group 202 has the group key GS2;

the group 203 has the group key GS3.

The multicast data transfer can be provided, for example, such that the node K3 receives data and can forward them to all the nodes connected to it in its group, i.e. the nodes K7, K8 and K9, at once, in which case it need recode the received data only a single time. If, by way of example, the node K3 receives data from the node K1, then these data have been encrypted using the group key GS1, and the node K3 converts the data, that is to say decrypts the data and encrypts them again using the group key KS3. It then transmits the newly encrypted data to the nodes K7 to K9.

If a new node is then added, the group key needs to be negotiated again only for a tree section, that is to say for a group (see groups 201, 202 or 203 in FIGS. 2 to 4), since the tree section changes for the group. This advantageously means that not every node in the entire hierarchical structure, in this case the entire tree, is affected, but rather only those nodes of a group in which the change is made. Such a change can involve, by way of example, the addition of a new node, the removal of an already existing node, or the changing of particular parameters for a node (or for a plurality of nodes).

The advantages of the solution are, in particular, that the node need recode the data only once, and multicast data transfer can also be ensured using protected data links. New keys are renegotiated only for part of the entire hierarchical structure when a node is altered (added, removed, changed). In addition, the method for key distribution (key management) is economically distributed over a plurality of nodes.

Optionally, the method for key distribution can also be organized on a hierarchical basis. In this case, it is particularly important for the node initiating the method for key distribution to have a superordinate node to which it is directly connected. The initiator negotiates a security union with the subordinate nodes which are directly connected to it. Optionally, the initiator can also agree the security conditions with the superordinate nodes, the security conditions serving as a basis for the method for key distribution with the subordinate node. Alternatively, the initiator can also determine the security conditions independently of the other nodes and can use them in the method for key distribution (key management). In this case, the method for key distribution (key management) is distributed over a plurality of subordinate nodes by the root node on an administrative basis, as a result of which the root node is relieved of load, that is to say the work for the method for key distribution is distributed over a plurality of nodes.

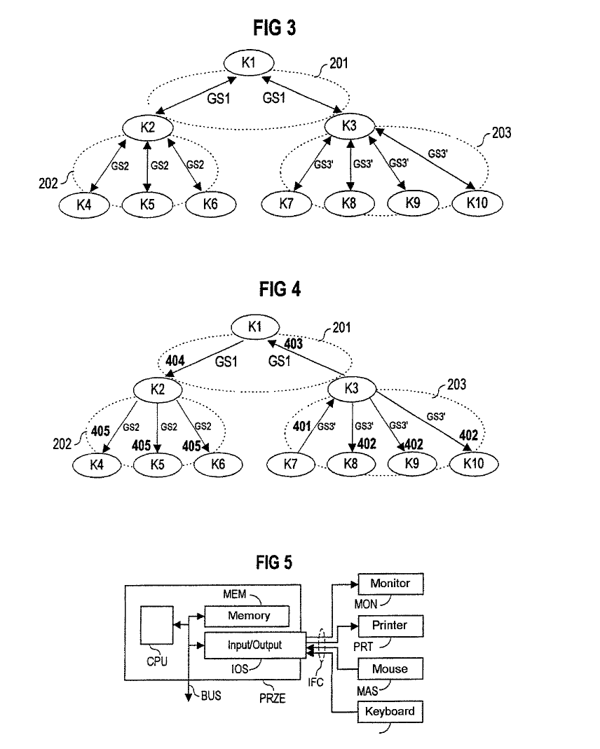

In the manner of FIG. 2, FIG. 3 again shows the hierarchical structure comprising the nodes K1 to K9. A new feature in this case is a node K10 which is arranged below the node K3. This addition of the node K10 indicates that new group keys GS3′ need to be distributed within the security union 203 (=the group 203) if the addition of the node K10 changes anything about the properties of the security union.

In the present case of FIG. 3, a new key GS3′ is negotiated for the security union 203, the new key then being transmitted in encrypted form to the nodes (in this case: nodes K7, K8 and K9) which are on a hierarchical level with node K10 and have a common hierarchically superordinate node (in this case: K3). The rest of the nodes K1, K2, K4, K5 and K6 remain completely unaffected by the renegotiation of the group key GS3′ and hence by the addition of the node K10.

FIG. 4 shows a hierarchical structure in accordance with FIG. 3, with an illustration being given of how a message can be transmitted from a node K7 to all the other nodes in the hierarchical structure. If the node K7 (see data 401) sends data to all the other nodes in the tree structure, then the nodes which are on its hierarchical level and have a common, direct, hierarchically superordinate node K3 with the node K7 receive these data first in unencrypted form. This applies to the nodes K8, K9 and K10, each of which respectively receives the data 402. The node K3 needs to encrypt the data again once (see data 403, encrypted using the key GS1) and forwards them to the node K1. This node K1 transmits the data without recoding to the node K2 (see data path 404). The node K2 in turn performs recoding using group key GS2 and transmits the data (see data path 405) to the nodes K4, K5 and K6 present in its group.

FIG. 5 shows a processor unit PRZE. The processor unit PRZE comprises a processor CPU, a memory MEM and an input/output interface IOS which can be used in various ways via an interface IFC. A graphical interface can be used to display an output on a monitor MON, and/or to output it on a printer PRT, and/or to output to any other type of output device. An input can be made using a mouse MAS, and/or a keyboard TAST, and/or using any other type of input device. The processor unit PRZE also may include a data bus BUS for connecting a memory MEM, the processor CPU and the input/output interface IOS, etc. Additional components can also be connected to the data bus BUS, e.g. an additional memory, a data store (hard disk), a scanner, etc. The processor unit can be used for carrying out any of the above-mentioned methodology of each of the various embodiments of the present application.

The following publications have been cited within the scope of this document, each of which is hereby incorporated herein by reference:

[1] Christoph Ruland: Informationssicherheit in Datennetzen [Information Security in Data Networks], DATACOM-Verlag, Bergheim, 1993, pages 155 ff.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for data communication in a cryptographic system containing a plurality of entities, comprising:
arranging the plurality of entities in a hierarchical structure; and
notifying, if a current entity is altered, those entities, which are on a same hierarchical level as the current entity and which are connected to a hierarchically superordinate entity of the current entity, of the alteration.

2. The method as claimed in claim 1, wherein the data communication includes key distribution.

3. The method as claimed in claim 1, wherein the plurality of entities include at least one of nodes and subscribers to the data communication.

4. The method as claimed in claim 1, wherein the plurality of entities are amalgamated in a network.

5. The method as claimed in claim 1, wherein the hierarchical structure is a tree structure.

6. The method as claimed in claim 1, wherein the alteration of the current entity includes at least one of the following options:
the current entity is added;
the current entity is removed;
at least one property of the current entity is altered.

7. The method as claimed in claim 1, wherein notifying includes transmitting the notification of alteration involves a modified cryptographic key.

8. The method as claimed in claim 1, wherein the method is for implementing multicast services.

9. An arrangement for data communication in a cryptographic system containing a plurality of entities, comprising:
a processing unit, provided such that the plurality of entities are arranged in a hierarchical structure, and provided to notify, if a current entity is altered, those entities which are on a same hierarchical level as the current entity and which are connected to a hierarchically superordinate entity of the current entity, of the alteration.

10. The method as claimed in claim 2, wherein the plurality of entities include at least one of nodes and subscribers to the data communication.

11. The method as claimed in claim 2, wherein the plurality of entities are amalgamated in a network.

12. The method as claimed in claim 3, wherein the plurality of entities are amalgamated in a network.

13. The method as claimed in claim 2, wherein the alteration of the current entity includes at least one of the following options:
the current entity is added;
the current entity is removed;
at least one property of the current entity is altered.

14. The method as claimed in claim 3, wherein the alteration of the current entity includes at least one of the following options:
the current entity is added;
the current entity is removed;
at least one property of the current entity is altered.

15. The method as claimed in claim 4, wherein the alteration of the current entity includes at least one of the following options:
the current entity is added;
the current entity is removed;
at least one property of the current entity is altered.

16. The method as claimed in claim 2, wherein notifying includes transmitting the notification of alteration involves a modified cryptographic key.

17. The method as claimed in claim 3, wherein notifying includes transmitting the notification of alteration involves a modified cryptographic key.

18. The method as claimed in claim 4, wherein notifying includes transmitting the notification of alteration involves a modified cryptographic key.

19. The arrangement of claim 9, wherein the data communication includes key distribution.

20. The arrangement of claim 9, wherein the plurality of entities include at least one of nodes and subscribers to the data communication

21. The arrangement of claim 9, wherein the plurality of entities are amalgamated in a network.
